(19) United States
(12) Patent Application Publication
(10) Pub. No.: US 2015/0192209 A1
(43) Pub. Date: Jul. 9, 2015

(54) INLET CLOSURE MECHANISM

(71) Applicant: Smiths Detection-Watford Limited, Watford (GB)

(72) Inventor: John Patrick Fitzgerald, Watford (GB)

(21) Appl. No.: 14/419,764

(22) PCT Filed: Aug. 8, 2013
(86) PCT No.: PCT/GB2013/052127

§ 371 Date: Feb. 5, 2015

Related U.S. Application Data
(60) Provisional application No. 61/693,844, filed on Aug. 28, 2012.
(60) Provisional application No. 61/680,865, filed on Aug. 8, 2012.

(51) Int. Cl. F16K 3/316; F16K 27/04; F16K 3/22

(52) U.S. Cl. CPC F16K 3/3165; F16K 3/22; F16K 27/04

(57) ABSTRACT

An inlet closure assembly includes a housing that defines an inlet configured to receive a fluid, such as airflow from the surrounding environment. The inlet closure assembly also includes a seal member that defines an inlet path in fluid communication with the inlet defined by the housing. The inlet closure assembly further includes a seat member configured to seat with respect to the seal member. The seat member is configured to obstruct the inlet path in its seated orientation. The inlet closure assembly also includes an actuation member configured to move the seat member into and out of seated engagement with the seal member. The inlet closure assembly further includes a biasing member for biasing the seat member into seated engagement with the seal member when the seat member is positioned to obstruct the inlet. The biasing member can be implemented using a magnet, a spring, and so forth.

### BACKGROUND

Ion mobility spectrometry refers to an analytical technique that can be used to separate and identify ionized material, such as molecules and atoms. Ionized material can be identified in the gas phase based on mobility in a carrier buffer gas. Thus, an ion mobility spectrometer (IMS) can identify material from a sample of interest by ionizing the material and measuring the time it takes the resulting ions to reach a detector. An ion's time of flight is associated with its ion mobility, which relates to the mass and geometry of the material that was ionized. The output of an IMS detector can be visually represented as a spectrum of peak height versus drift time. In some instances, IMS detection is performed at an elevated temperature (e.g., above one hundred degrees Celsius (100° C.)). In other instances, IMS detection can be performed without heating. IMS detection can be used for military and security applications, e.g., to detect drugs, explosives, and so forth. IMS detection can also be used in laboratory analytical applications, and with complementary detection techniques such as mass spectrometry, liquid chromatography, and so forth.

### SUMMARY

An inlet closure assembly for a housing that defines an inlet configured to receive a fluid, such as airflow from the surrounding environment, is described. The inlet closure assembly includes a seal member that defines an inlet path in fluid communication with the inlet defined by the housing. The inlet closure assembly includes a seat member configured to seat with respect to the seal member. The seat member is configured to obstruct the inlet path in its seated orientation. The inlet closure assembly also includes an actuation member configured to move the seat member into and out of seated engagement with the seal member. The inlet closure assembly further includes a biasing member for biasing the seat member into seated engagement with the seal member when the seat member is positioned to obstruct the inlet. The biasing member can be implemented using a magnet, a spring, and so forth.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identify the figure in which the reference number first appears. The use of the same reference number in different instances in the description and the figures may indicate similar or identical items.

FIG. 1A is a partial isometric view illustrating an inlet closure assembly including a magnetic biasing member disposed between an inlet and a seal member configured as a gasket ring for biasing a seat member into seated engagement with the seal member in accordance with example implementations of the present disclosure.

FIG. 1B is a partial isometric view illustrating an inlet closure assembly including a magnetic biasing member disposed between an inlet and a seal member configured as an O-ring for biasing a seat member into seated engagement with the seal member in accordance with example implementations of the present disclosure.

FIG. 1C is a partial isometric view illustrating an inlet closure assembly including a magnetic biasing member disposed between an inlet and a seal member configured as a gasket ring for biasing a hollow seat member into seated engagement with the seal member in accordance with example implementations of the present disclosure.

FIG. 1D is a partial isometric view illustrating an inlet closure assembly including a magnetic biasing member disposed adjacent to an inlet and a seal member for biasing a seat member into seated engagement with the seal member, where the seat member is held in a cage in accordance with example implementations of the present disclosure.

FIG. 1E is a partial isometric view illustrating an inlet closure assembly including a magnetic biasing member disposed between an inlet and a seal member for biasing a seat member into seated engagement with the seal member, where the seat member is moved using a slide arm in accordance with example implementations of the present disclosure.

FIG. 1F is a partial isometric view illustrating an inlet closure assembly including a magnetic biasing member disposed between an inlet and a seal member for biasing a seat member into seated engagement with the seal member, where the seat member is moved using a slide arm comprising a fluid passage in accordance with example implementations of the present disclosure.

FIG. 1G is a partial isometric view illustrating an inlet closure assembly including a magnetic biasing member disposed between an inlet and a seal member for biasing a seat member into seated engagement with the seal member, where the seat member is moved using a lever arm for opening and closing two separate inlets in accordance with example implementations of the present disclosure.

FIG. 1H is a partial isometric view illustrating an inlet closure assembly including a spring biasing member for biasing a seat member into seated engagement with a seal member in accordance with example implementations of the present disclosure.

FIG. 1J is a partial isometric view illustrating an inlet closure assembly including a first magnetic biasing member disposed between an inlet and a first seal member for biasing a seat member into seated engagement with the first seal member, and a second magnetic biasing member for biasing the seat member out of seated engagement with the first seal member in accordance with example implementations of the present disclosure.

FIG. 2A is a diagrammatic illustration of a system including a controller operatively coupled with an actuation module of a sample detector, where the controller can be used to control operation of the actuation module to open and close one or more inlets of the sample detector.

FIG. 2B is a diagrammatic illustration of a system including a controller operatively coupled with a sample detector, where the controller can be used to control operation of an actuation module to open and close one or more inlets of the sample detector.

### DETAILED DESCRIPTION

Many sample detectors employ sample detection techniques that require detection instrumentation to operate using dry, or at least substantially dry, internal operating conditions. For example, Ion Mobility Spectrometer (IMS) instrumentation generally requires that air in a spectrometry cell is drier than, for instance, the ambient atmosphere. Thus, IMS equipment typically employs techniques to remove water vapor from IMS cells, associated pneumatic paths, and so forth. These equipment configurations may include a pneumatic pump and a desiccant, such as a material containing small pores having a uniform size for use as an adsorbent for gases and/or liquids (referred to as a “molecular sieve”). In other configurations, a sample inlet of an IMS detector provides an interface to external air using a membrane, which can be configured to allow vapor to permeate through while substantially preventing water from entering an IMS detector cell.

In some instances, a small hole (referred to as a “pinhole”) can be used with an IMS detector sample inlet to provide an interface to external air. In this configuration, the pinhole allows a small volume of external air to be drawn into an IMS cell on demand. Although the pinhole can remain open (e.g., uncovered) while in use for detection operations, it may be desirable to close (e.g., seal) the pinhole when an IMS detector is not in use. Sealing a pinhole can prevent diffusion of comparatively wet air into a cell, which can lead to accelerated expiry of an internal desiccant. One technique for closing a pinhole sample inlet is to use a closure, such as a cap having a pneumatic sealing gasket, which can be used to cover the entire inlet of an IMS device. A cap can be sealed and unsealed by an operator using, for example, a twisting motion to raise and lower the cap (e.g., where the cap is threaded and coupled with an inlet of an IMS device). In some instances, automated techniques for opening and closing an inlet of an IMS detector can be provided, such as motorized components for raising and lowering a cap. However, the resulting mechanism can be bulky, which may interfere with the flow of external air into the IMS cell, and may consume a significant amount of power to open and/or close. A “pinhole” sampling inlet may comprise an aperture having a diameter of at least 0.1 mm, optionally at least 0.25 mm, for example less than 2 mm, for example less than 1 mm. Some “pinhole” sampling inlets comprise apertures of about 0.5 mm diameter, for example between 0.3 mm and 0.7 mm. In some examples the aperture is defines a hole having one of these diameters, and a depth of about 3 mm. As will be appreciated by a skilled person in the context of the present disclosure, the pinhole sampling inlet need not be circular, and apertures of other shapes having the same width, or the same cross sectional area, as circular apertures of these diameters may also be used.

Techniques are described for opening (e.g. uncovering) and closing (e.g., pneumatically sealing) an inlet, such as a pinhole inlet for an IMS detector. In some instances, the techniques disclosed herein can be used with automated and/or remote operation of an inlet, such as to facilitate automatic opening and closing procedures. Techniques in accordance with the present disclosure employ an inlet closure assembly that can be implemented using relatively small size, low mass, and/or low power instrumentation, e.g., as compared to closure mechanisms that cover an entire inlet of an IMS device. In implementations, the inlet closure assembly may allow the inlet to be automatically opened (e.g., uncovered) and closed (e.g., sealed) such that power may be employed only when opening and closing the inlet, while no power, or at least substantially no power, is required to maintain the inlet in an opened and/or closed orientation at other times. Further, a closure or seal configured in this manner may be resistant to mechanical shock and/or aging effects. For example, a closing mechanism can include a self-seating closing configuration implemented using a circular gasket and a substantially spherical obstruction that can be seated and unseated in the circular gasket.

In implementations, the inlet closure assembly furnishes a closure or seal using a mechanically simple configuration comprising, for example, two parts, both of which can be fully, or at least partially, provided using inert materials, chemically resistant materials, surface treatments, and so forth. Further, components of an inlet closure assembly can be configured to use simple geometrical shapes, which may not require high precision fabrication techniques and may be economically manufactured. For example, one or more ferritic ball bearings, O-rings, washers, and/or gaskets may be used to furnish the functionality described herein. Further, small size and/or low mass components may permit opening and closing of an inlet using comparatively small, low power actuation techniques, which may be desirable for miniature and/or battery powered implementations. For example, with small or miniature IMS detectors, reduced size, low mass, and/or low power characteristics can be important design considerations. However, this example is not meant to be restrictive of the present disclosure. The techniques disclosed herein can also be used with larger, non-portable devices.

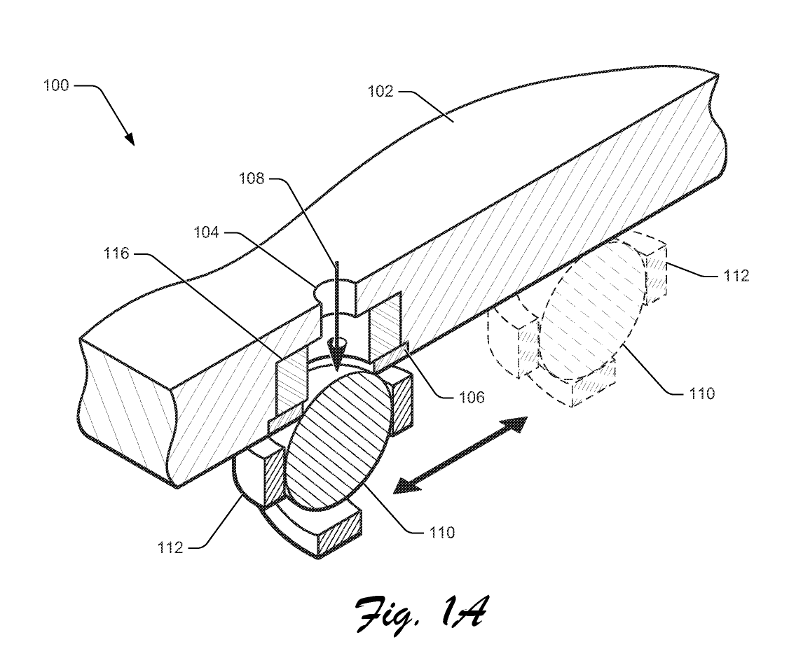

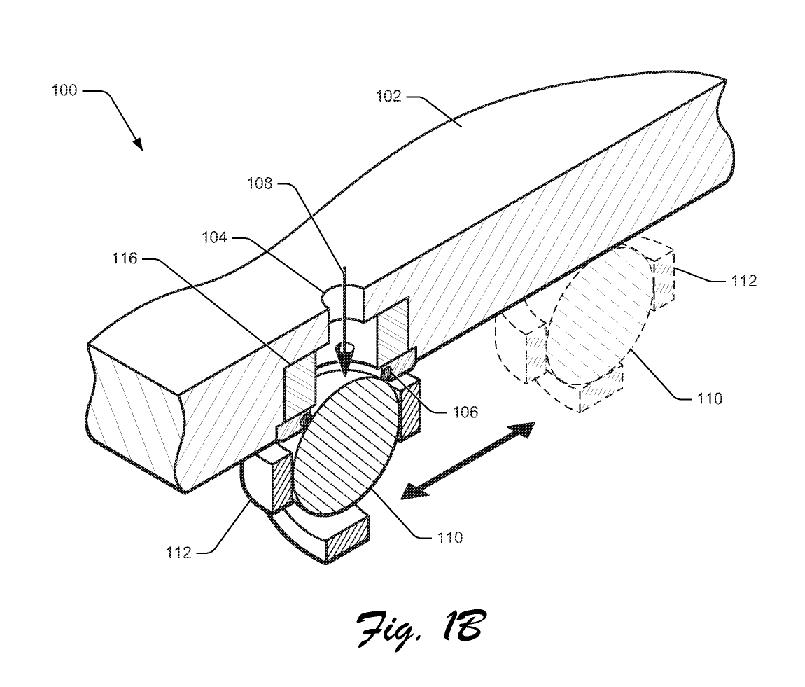

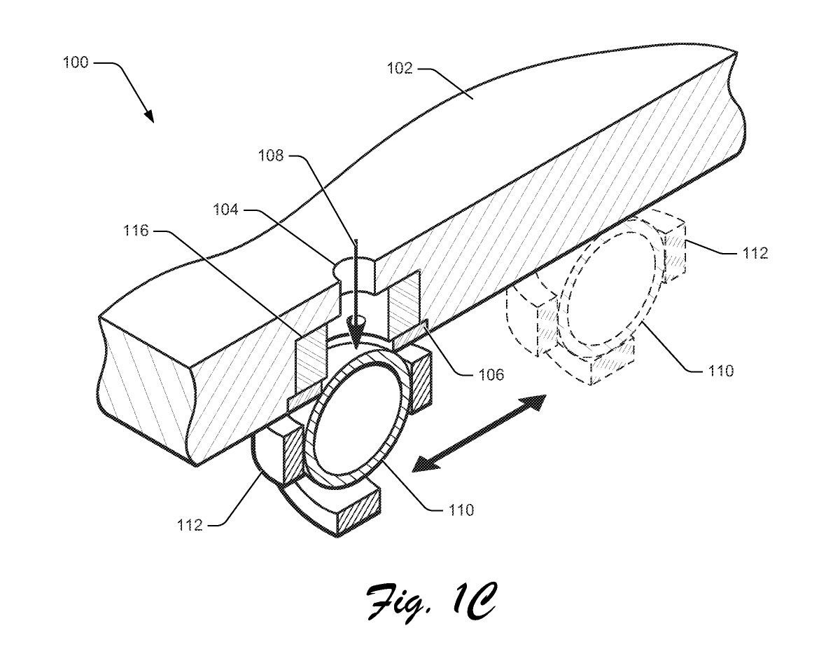

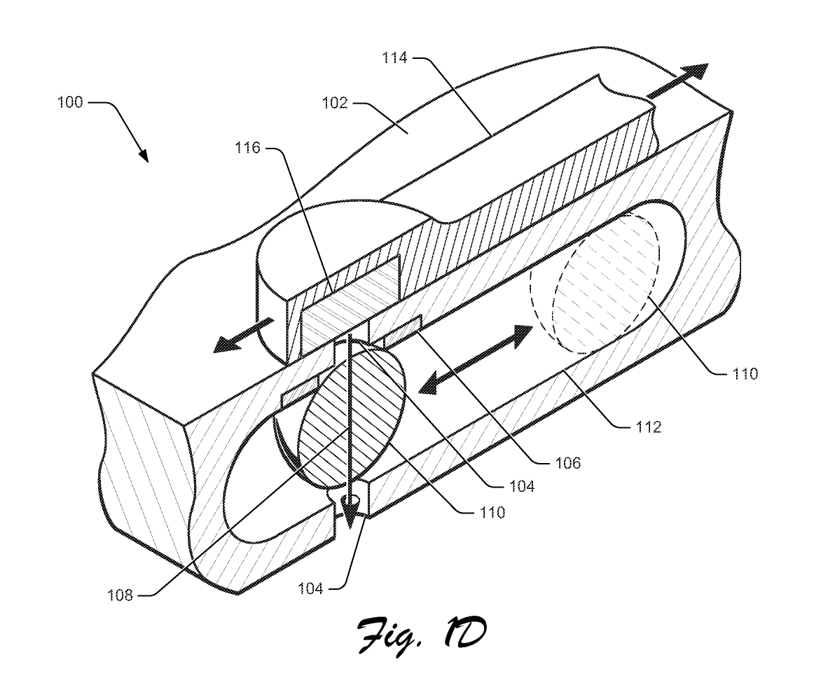

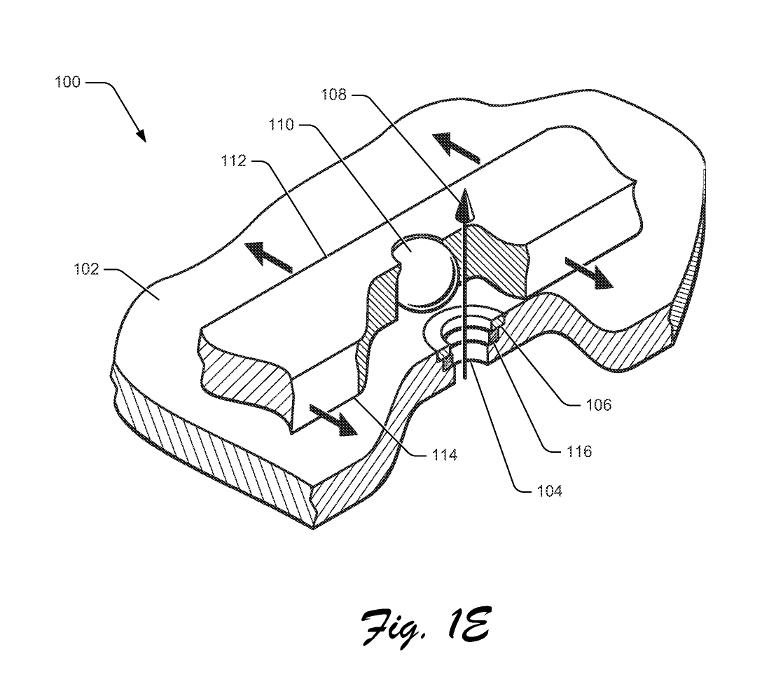

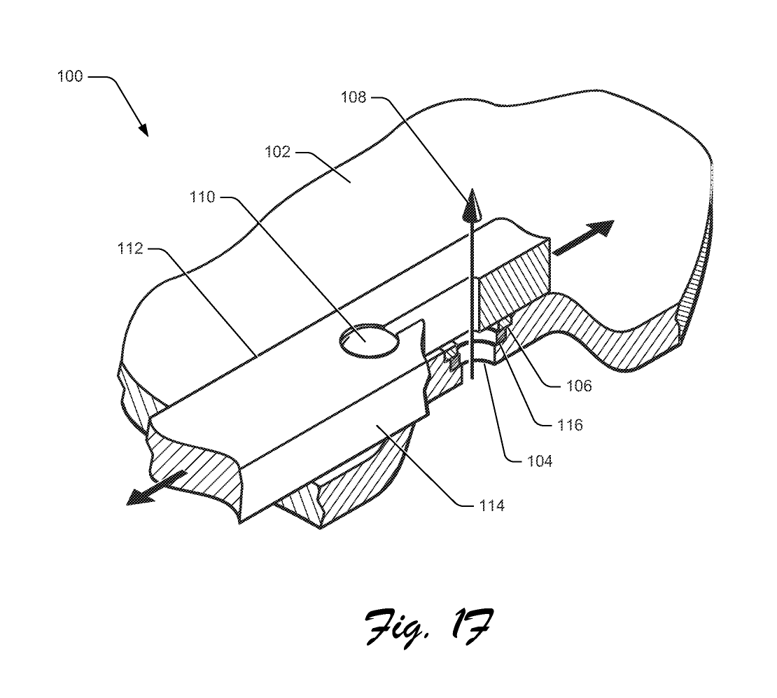

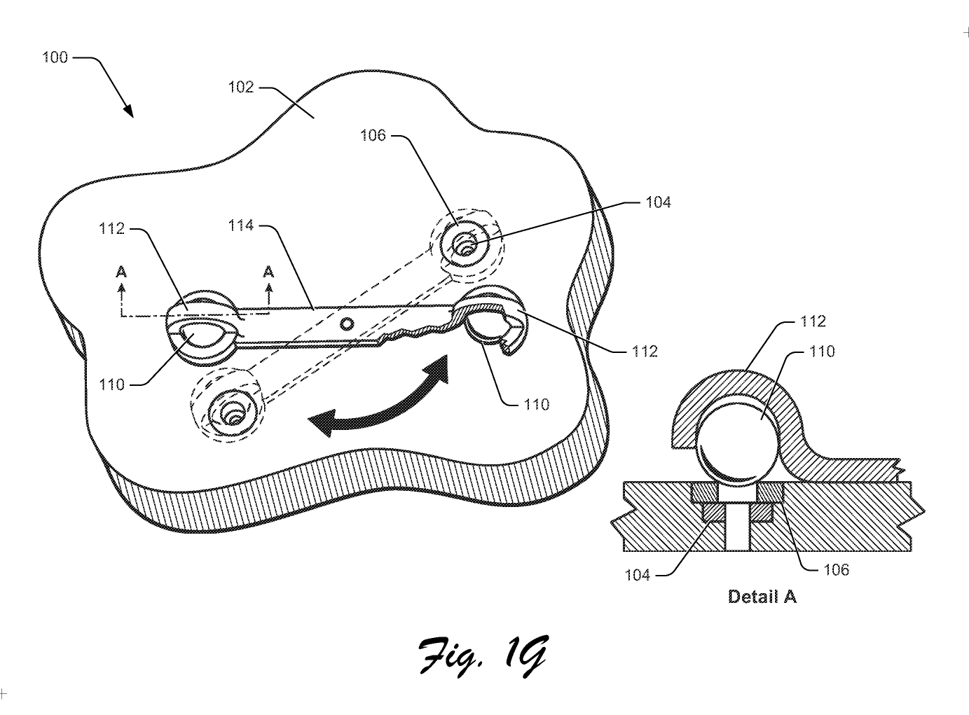

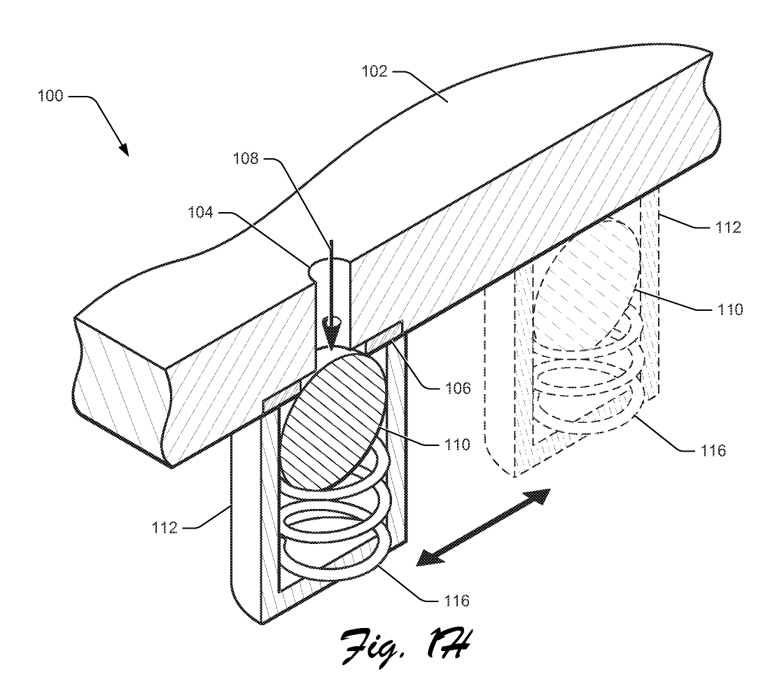

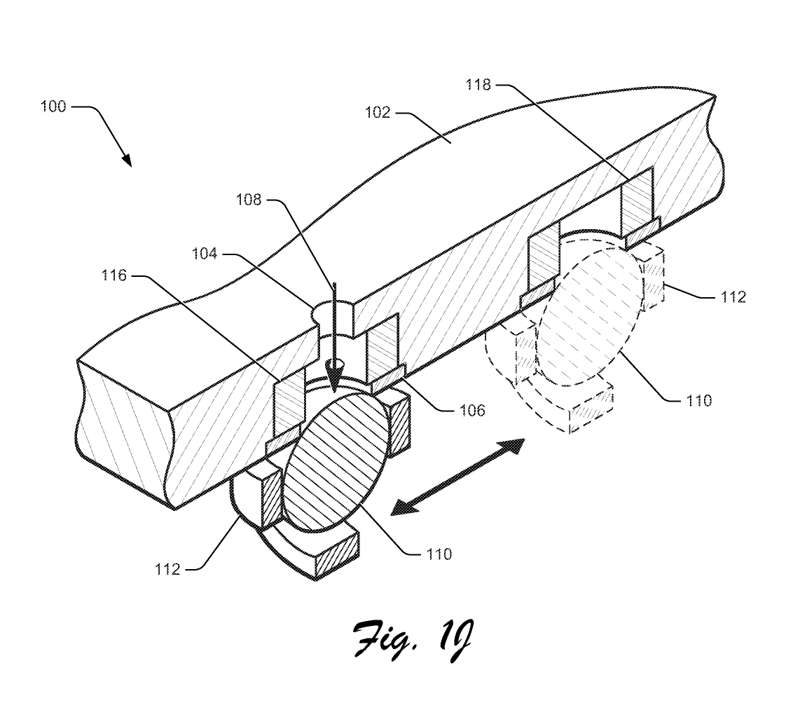

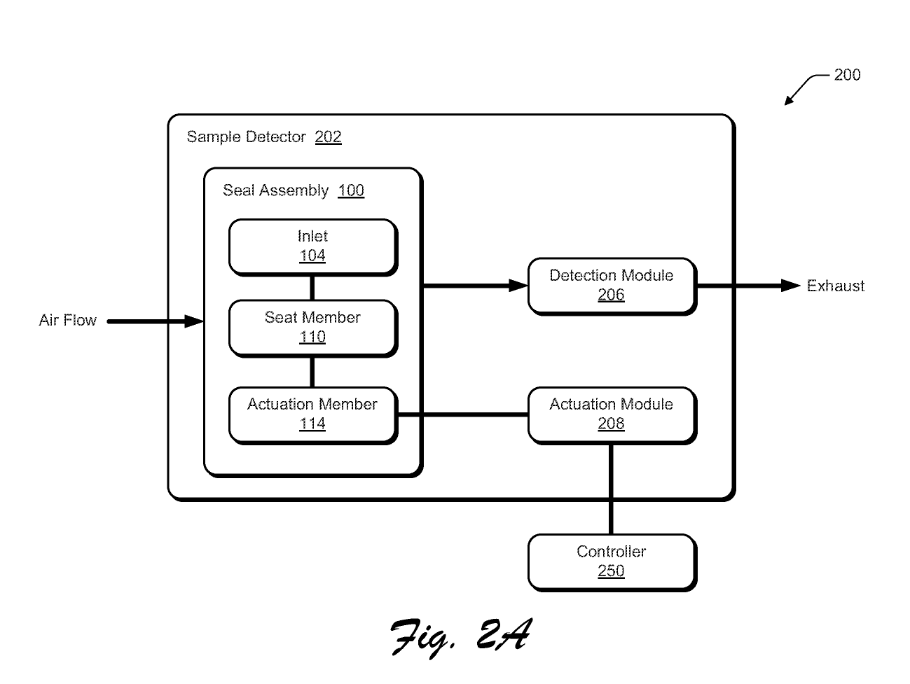

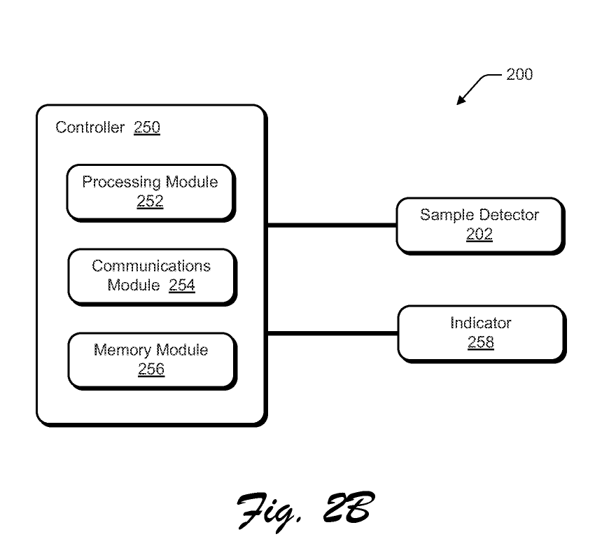

Referring now to FIGS. 1A through 1J, an inlet closure assembly 100 is described. In implementations, the inlet closure assembly 100 may be configured for use with the sample detector 202 illustrated in FIGS. 2A and 2B, although other implementations are contemplated. The inlet closure assembly 100 is provided in a housing 102, which can be used to house, for example, sample detection instrumentation, such as an ionization region/chamber of a spectrometry system. However, a spectrometry system is provided by way of example only and is not meant to be restrictive of the present disclosure. Thus, the inlet closure assembly 100 can be used with a wide range of other devices. The housing 102 defines an inlet 104, which is configured to receive a fluid, such as air from an environment proximate to the inlet closure assembly 100. In some instances, multiple inlets can be defined by a housing 102 and included with an inlet closure assembly 100, such as a second inlet 104, a third inlet, or more than three inlets. Each inlet 104 can be included with, for example, an IMS detector cell and used to supply air containing a sample of interest to the detector cell. For example, one or more inlets 104 can be configured as pinhole sample inlets. In some instances, an inlet closure assembly 100 may include one or more fans for supplying air to and/or from an inlet 104, while in other instances a fan is not necessarily included with an inlet closure assembly 100. In an instance where a fan is not included, a pressure pulse generated on the inside of a detector cell may be used to draw air through an inlet 104 (e.g., once every five seconds (5 sec)). In other instances, pressurized gas and/or a vacuum can be used to draw air through an inlet 104.

The inlet closure assembly 100 includes a seal member 106 positioned proximate (e.g., in close proximity and/or adjacent) to the inlet 104. The seal member 106 at least partially defines an inlet path 108, which is in fluid communication with the inlet 104 defined by the housing 102. In implementations, the seal member 106 may be configured as a mechanical sealing member that acts under compression, such as a gasket (e.g., a gasket ring or circular gasket as illustrated in FIGS. 1A and 1C through 1J), a washer, an O-ring (e.g., as illustrated in FIG. 1B), and so forth. The seal member 106 may be constructed using inert materials, chemically resistant materials, surface treatments, surface finishes, and so forth, which can be selected to avoid instrument contamination. For example, a seal member 106 configured as a gasket may be constructed from an inert, or at least substantially inert, material such as a synthetic rubber and fluoropolymer elastomer material coated with Fluorinated Ethylene Propylene (FEP). However, these materials are provided by way of example only and are not meant to be restrictive of the present disclosure. Thus, other materials may be used, including low-friction, non-reactive materials, and so forth. Further, a seal member 106 may be fully, or at least partially, defined by a housing 102 in some instances, such as co-molded with a housing 102, insert molded with a housing 102, and so forth. For example, in some instances, the seal member 106 may be formed in the housing 102 and define the inlet 104.

The inlet closure assembly 100 also includes a seat member (e.g., self-centering seat member 110) configured to seat with respect to the seal member 106 and obstruct the inlet path 108. For example, the seat member 110 may be at least generally spherical, and configured to seal against the seal member 106 in an orientation-independent manner when the seat member 110 is in seated engagement with the seal member 106. In some instances, the seat member 110 may comprise a ball bearing, which can be formed using, for example, ferritic stainless steel, and may be plated, coated, and so forth (e.g., using a chemical vapor deposited polymer). Further, the seat member 110 may be hollow, comprising, for example, a hollow shell configuration to reduce the mass of the seat member 110 in the case of a larger scale device (e.g., as illustrated in FIG. 1C). In implementations, the seat member 110 can be between at least approximately two millimeters (2 mm) and one-half inch (0.5 inch) in diameter. However, this range is provided by way of example only and is not meant to be restrictive of the present disclosure. Thus, in other configurations, a seat member 110 may be larger or smaller than the range of diameters described above. Further, a generally spherical shape is provided by way of example only and is not meant to be restrictive of the present disclosure. Thus, other shapes can be used for the seat member 110, including a roller, a wedge shape, a bullet shape, a truncated conical shape, an oblong (e.g., elliptical) shape, and so forth. In some instances, a seat member configured as a roller can be positioned in a matching channel. In this configuration, the seat member may not necessarily be centered with respect to a longitudinal axis defined along the length of the channel. Thus, the roller may be wider in a direction coincident with its axis of rotation than the opening of the inlet 104 (e.g., to account for positional variation within the channel).

The seat member 110 may also be constructed using inert materials, chemically resistant materials, surface treatments, surface finishes, and so forth, which can be selected to avoid instrument contamination. For example, a seat member 110 configured as a ball bearing may be coated with an inert, or at least substantially inert, material such as a chemical vapor deposited polymer and/or Polytetrafluoroethylene (PTFE). However, these materials are provided by way of example only and are not meant to be restrictive of the present disclosure. Thus, other materials may be used, including low-friction, non-reactive materials, and so forth. In some instances, the seat member 110 may be fully or partially constructed using a magnetic material.

The inlet closure assembly 100 may also include a keeper 112 coupled with the seat member 110 and configured to allow the seat member 110 to move between one position where the seat member 110 is in seated engagement with the seal member 106 (e.g., covering and/or sealing the inlet 104), and another position where the seat member 110 is out of seated engagement with the seal member 106 (e.g., uncovering the inlet 104). In implementations, the keeper 112 may be configured as a cage, a basket, a fork, and so forth, for retaining the seat member 110, while allowing the seat member 110 to move to cover and uncover the inlet 104. For example, the seat member 110 can be loosely held captive in a cage construction, configured to allow sufficient free movement of the seat member 110 for sealing (e.g., as illustrated in FIG. 1D). In this instance, the keeper 110 can be defined by the housing 102. In some instances, the keeper 112 can be constructed from one or more materials selected to avoid instrument contamination, such as one or more plastic materials or the like.

The inlet closure assembly 100 may also include an actuation member 114 for moving the seat member 110 between one position where the seat member 110 is in seated engagement with the seal member 106 (e.g., covering and/or sealing the inlet 104), and another position where the seat member 110 is out of seated engagement with the seal member 106 (e.g., uncovering the inlet 104). In some instances, the actuation member 114 may be coupled with the keeper 112 for actuating the keeper 112 to move the seat member 110 (e.g., between seated and unseated positions as previously described). In implementations, the actuation member 114 can be implemented as a slide arm for linear translation (e.g., as illustrated in FIGS. 1E and 1F), a lever arm for rotational translation (e.g., as illustrated in FIG. 1G), and so forth. In the configuration shown in FIG. 1F, the actuation member 114 may define a fluid passage, such as an aperture, a channel, and so forth, for permitting fluid to enter the inlet 104 when the actuation member 114 is moved to uncover the inlet 104. In other implementations, the actuation member 114 may comprise a trap door used to move the seat member 110. The actuation member 114 can be actuated in a number of ways. For example, in one particular instance, the actuation member 114 may comprise a shape memory material (e.g., a shape memory alloy or a shape memory polymer) configured to assume a particular configuration based upon an input, such as a temperature change.

In some instances, the actuation member 114 can be actuated mechanically, electromagnetically, piezoelectrically, and so forth. For example, the actuation member 114 can be coupled with a solenoid for moving the actuation member 114. The actuation member 114 can also be coupled with, for instance, a linear or rotary electromagnetic motor, and/or a linear or rotary piezoelectric motor for moving the actuation member 114 (e.g., via a gear coupled with a linear or rotary motor). However, these actuation techniques are provided by way of example only and are not meant to be restrictive of the present disclosure. Thus, in other implementations, different techniques may be used to actuate the actuation member 114, such as piezoelectric beam actuation techniques, pneumatic force actuation techniques, and so forth.

A portion of the actuation member 114 can extend out of the housing 102 and/or connect to a mechanism on the exterior of the housing 102 for manual actuation by an operator. Indicia, symbols, and/or other markings can be included on the exterior of, for instance, a sample detector housing to alert an operator to the position of the seat member 110 with respect to the seal member 106. Additionally, a feedback mechanism can be implemented using a sensor to determine the position of the seat member 110, such as a non-contact optical sensor for determining the position and/or orientation of the actuation member 114, and so forth. The position can be displayed, using, for example, an indicator (e.g., indicator 258 as illustrated in FIG. 2B).

In implementations, the inlet closure assembly 100 includes a biasing member 116 positioned proximate to the inlet 104 for biasing the seat member 110 into seated engagement with the seal member 106. In implementations where the biasing member 116 is positioned between the inlet 104 and the seal member 106, the biasing member 116 can at least partially define the inlet path 108 in fluid communication with the inlet 104 defined by the housing 102 (e.g., in combination with the seal member 106). For example, the biasing member 116 can be implemented as a magnet, such as a ring-shaped permanent magnet (e.g., a rare earth magnetic ring), positioned between the seal member 106 and the inlet 104 (e.g., as illustrated in FIGS. 1A through 1C and 1E through 1J). In other configurations, a magnetic biasing member 116 can be positioned on an opposite side of the inlet 104 with respect to the seal member 106 (e.g., as illustrated in FIG. 1D). In this configuration, the actuation member 114 may be coupled with the biasing member 116 for actuating the biasing member 116 to move the seat member 110 (e.g., between seated and unseated positions as previously described). In some instances, the biasing member 116 can be configured to attract the seat member 110. In other instances, the biasing member 116 can be configured to repel the seat member 110.

Magnetic materials that can be used for the biasing member 116 can include, but are not necessarily limited to: Neodymium Iron Boron, Samarium Cobalt, and so forth. Further, in some implementations, a magnetic material can be selected based upon operating temperatures, and may be plated, coated, and so forth. It should be noted that these magnetic materials are provided by way of example only and are not meant to be restrictive of the present disclosure. A biasing member 116 can be furnished using other components and/or techniques configured to produce a magnetic field for interacting with a seat member 110, such as a magnet implemented as an electromagnet, and so forth. However, a magnetic biasing member is provided by way of example only and is not meant to be restrictive of the present disclosure. Thus, in other implementations the biasing member 116 may be implemented as a spring (e.g., as illustrated in FIG. 1H), and so forth. In this manner, the seat member 110 can be held in place by, for instance, magnetic force and/or spring force furnished by the biasing member 116 when the seat member 110 is in seated engagement with the seal member 106. Thus, the inlet 104 can be biased closed when power is not supplied to the inlet closure assembly 100. The biasing member 116 can also be used to hold the seat member 110 in place and resist the shock of a sudden movement and/or impact. The sealing force provided by the biasing member 116 can be overcome and the seat member 110 can be moved to a different location when desired, unsealing the inlet 104 and allowing the inlet 104 to be used to transmit fluid (e.g., for vapor sampling).

In some implementations, the inlet closure assembly 100 may include a second biasing member 118 positioned apart from the inlet 104 for biasing the seat member 110 into another position where the seat member 110 is out of seated engagement with the seal member 106 (e.g., as illustrated in FIG. 1J). In these configurations, the inlet closure assembly 100 may be bi-stable, such that power is only required to move the seat member 110 when covering and uncovering the inlet 104. Further, two or more separate inlets 104 can be covered and uncovered simultaneously, using, for instance, a mechanical linkage, where an actuation member 114 configured as a lever arm is pivoted about its center, and where two or more inlets 104 are configured as mirror images of one another (e.g., as illustrated in FIG. 1G).

FIG. 2 is an illustration of a spectrometer system, such as an ion mobility spectrometer (IMS) system 200. Although IMS detection techniques are described herein, it should be noted that a variety of different spectrometers can benefit from the structures, techniques, and approaches of the present disclosure. It is the intention of this disclosure to encompass and include such changes. IMS systems 200 can include spectrometry equipment that employs unheated (e.g., surrounding (ambient or room) temperature) detection techniques. For example, an IMS system 200 can be configured as a lightweight explosive detector. However, it should be noted that an explosive detector is provided by way of example only and is not meant to be restrictive of the present disclosure. Thus, techniques of the present disclosure may be used with other spectrometry configurations. For example, an IMS system 200 can be configured as a chemical detector. An IMS system 200 can include a detector device, such as a sample detector 202 having a sample receiving port for introducing material from a sample of interest to an ionization region/chamber. For example, the sample detector 202 can have an inlet 104 where air to be sampled is admitted to the sample detector 202. In example implementations, the inlet 104 can be defined by a housing 102 as previously described. In some implementations, the sample detector 202 can have another device such as a gas chromatograph (not shown) connected in line with the IMS inlet 104.

The inlet 104 can employ a variety of sample introduction approaches. In some instances, a flow of air can be used. In other instances, IMS systems 200 can use a variety of fluids and/or gases to draw material into the inlet 104. Approaches for drawing material through the inlet 104 include the use of fans, pressurized gases, a vacuum created by a drift gas flowing through a drift region/chamber, and so forth. For example, the sample detector 202 can be connected to a sampling line, where air from the surrounding environment (e.g., room air) is drawn into the sampling line using a fan. IMS systems 200 can operate at substantially ambient pressure, although a stream of air or other fluid can be used to introduce sample material into an ionization region. In other instances, IMS systems 200 can operate at lower pressures (i.e., pressures less than ambient pressure). Further, IMS systems 200 can include other components to furnish introduction of material from a sample source. For example, a desorber, such as a heater, can be included with an IMS system 200 to cause at least a portion of a sample to vaporize (e.g., enter its gas phase) so the sample portion can be drawn into the inlet 104. For instance, a sample probe, a swab, a wipe, or the like, can be used to obtain a sample of interest from a surface. The sample probe can then be used to deliver the sample to the inlet 104 of an IMS system 200. IMS systems 200 can also include a pre-concentrator to concentrate or cause a bolus of material to enter an ionization region.

A portion of a sample can be drawn through an inlet 104 configured as a small aperture inlet (e.g., a pinhole) into the sample detector 202 using, for example, a diaphragm in fluid communication with an interior volume of the sample detector 202. For instance, when the internal pressure in the interior volume is reduced by movement of the diaphragm, a portion of the sample is transferred from the inlet 104 into the sample detector 202 through the pinhole. After passing through the pinhole, the sample portion enters a detection module 206. The detection module 206 can include an ionization region where the sample is ionized using an ionization source, such as a corona discharge ionizer (e.g., having a corona discharge point). However, a corona discharge ionizer is provided by way of example only and is not meant to be restrictive of the present disclosure. Other example ionization sources include, but are not necessarily limited to: radioactive and electrical ionization sources, such as a photoionization source, an electrospray source, a matrix assisted laser desorption ionization (MALDI) source, a nickel 63 source (Ni⁶³), and so forth. In some instances, the ionization source can ionize material from a sample of interest in multiple steps. For example, the ionization source can generate a corona that ionizes gases in the ionization region that are subsequently used to ionize the material of interest. Example gases include, but are not necessarily limited to: nitrogen, water vapor, gases included in air, and so forth.

In implementations, the detection module 206 can operate in positive mode, negative mode, switch between positive and negative mode, and so forth. For example, in positive mode the ionization source can generate positive ions from a sample of interest, while in negative mode the ionization source can generate negative ions. Operation of the detection module 206 in positive mode, negative mode, or switching between positive and negative mode can depend on implementation preferences, a predicted sample type (e.g., explosive, narcotic, toxic industrial chemicals), and so forth. Further, the ionization source can be pulsed periodically (e.g., based upon sample introduction, gate opening, the occurrence of an event, and so on).

The sample ions can then be directed toward a gating grid using an electric field. The gating grid can be opened momentarily to allow small clusters of sample ions to enter a drift region. For example, the detection module 206 can include an electronic shutter or gate at the inlet end of a drift region. In implementations, the gate controls entrance of ions to the drift region. For example, the gate can include a mesh of wires to which an electrical potential difference is applied or removed. The drift region has electrodes (e.g., focusing rings) spaced along its length for applying an electric field to draw ions along the drift region and/or to direct the ions toward a detector disposed generally opposite the gate in the drift region. For example, the drift region, including the electrodes, can apply a substantially uniform field in the drift region. The sample ions can be collected at a collector electrode, which can be connected to analysis instrumentation for analyzing the flight times of the various sample ions. For instance, a collector plate at the far end of the drift region can collect ions that pass along the drift region.

The drift region can be used to separate ions admitted to the drift region based on the individual ions' ion mobility. Ion mobility is determined by the charge on an ion, an ion's mass, geometry, and so forth. In this manner, IMS systems 200 can separate ions based on time of flight. The drift region can have a substantially uniform electrical field that extends from the gate to a collector. The collector can be a collector plate (e.g., a Faraday plate) that detects ions based on their charge as they contact the collector plate. In implementations, a drift gas can be supplied through the drift region in a direction generally opposite the ions' path of travel to the collector plate. For example, the drift gas can flow from adjacent the collector plate toward the gate. Example drift gases include, but are not necessarily limited to: nitrogen, helium, air, air that is re-circulated (e.g., air that is cleaned and/or dried) and so forth. For example, a pump can be used to circulate air along the drift region against the direction of flow of ions. The air can be dried and cleaned using, for instance, a molecular sieve pack.

In implementations, the sample detector 202 can include a variety of components to promote identification of a material of interest. For example, the sample detector 202 can include one or more cells containing a calibrant and/or a dopant component. Calibrant can be used to calibrate the measurement of ion mobility. Dopant can be used to selectively ionize molecules. Dopant can also be combined with a sample material and ionized to form an ion that can be more effectively detected than an ion that corresponds to the sample material alone. Dopant can be provided to one or more of the inlet 104, the ionization region and/or the drift region. The sample detector 202 can be configured to provide dopant to different locations, possibly at different times during operation of the sample detector 202. The sample detector 202 can be configured to coordinate dopant delivery with operation of other components of an IMS system 200.

A controller 250 can detect the change in charge on the collector plate as ions reach it. Thus, the controller 250 can identify materials from their corresponding ions. In implementations, the controller 250 can also be used to control opening of the gate to produce a spectrum of time of flight of the different ions along the drift region. For example, the controller 250 can be used to control voltages applied to the gate. Operation of the gate can be controlled to occur periodically, upon the occurrence of an event, and so forth. For example, the controller 250 can adjust how long the gate is open and/or closed based upon the occurrence of an event (e.g., corona discharge), periodically, and so forth. Further, the controller 250 can switch the electrical potential applied to the gate based upon the mode of the ionization source (e.g., whether the detection module 206 is in positive or negative mode). In some instances, the controller 250 can be configured to detect the presence of explosives and/or chemical agents and provide a warning or indication of such agents on an indicator 258.

In implementations, an IMS system 200, including some or all of its components, can operate under computer control. For example, a processor can be included with or in an IMS system 200 to control the components and functions of IMS systems 200 described herein using software, firmware, hardware (e.g., fixed logic circuitry), manual processing, or a combination thereof. The terms “controller” “functionality,” “service,” and “logic” as used herein generally represent software, firmware, hardware, or a combination of software, firmware, or hardware in conjunction with controlling the IMS systems 200. In the case of a software implementation, the module, functionality, or logic represents program code that performs specified tasks when executed on a processor (e.g., CPU or CPUs). The program code may be stored in one or more computer-readable memory devices (e.g., internal memory and/or one or more tangible media), and so on. The structures, functions, approaches, and techniques described herein can be implemented on a variety of commercial computing platforms having a variety of processors.

For example, as illustrated in FIG. 2B, the sample detector 202 may be coupled with the controller 250 for controlling the opening and closing of the inlet 104. For instance, the controller 250 may be coupled with an actuation module 208, which may include one or more solenoids, linear electromagnetic motors, rotary electromagnetic motors, linear piezoelectric motors, rotary piezoelectric motors, piezoelectric beam actuators, pneumatic force actuators, and so forth, for moving the actuation member 114 and opening and closing the inlet 104. The controller 250 may include a processing module 252, a communications module 254, and a memory module 256. The processing module 252 provides processing functionality for the controller 250 and may include any number of processors, micro-controllers, or other processing systems, and resident or external memory for storing data and other information accessed or generated by the controller 250. The processing module 252 may execute one or more software programs, which implement techniques described herein. The processing module 252 is not limited by the materials from which it is formed or the processing mechanisms employed therein, and as such, may be implemented via semiconductor(s) and/or transistors (e.g., using electronic integrated circuit (IC) components), and so forth. The communications module 254 is operatively configured to communicate with components of the sample detector 202. The communications module 254 is also communicatively coupled with the processing module 252 (e.g., for communicating inputs from the sample detector 202 to the processing module 252). The communications module 254 and/or the processing module 252 can also be configured to communicate with a variety of different networks, including but not necessarily limited to: the Internet, a cellular telephone network, a local area network (LAN), a wide area network (WAN), a wireless network, a public telephone network, an intranet, and so on.

The memory module 256 is an example of tangible computer-readable media that provides storage functionality to store various data associated with operation of the controller 250, such as software programs and/or code segments, or other data to instruct the processing module 252 and possibly other components of the controller 250 to perform the steps described herein. Thus, the memory can store data, such as a program of instructions for operating the IMS system 200 (including its components), spectral data, and so on. Although a single memory module 256 is shown, a wide variety of types and combinations of memory (e.g., tangible memory, non-transitory) may be employed. The memory module 256 may be integral with the processing module 252, may comprise stand-alone memory, or may be a combination of both.

The memory module 256 may include, but is not necessarily limited to: removable and non-removable memory components, such as Random Access Memory (RAM), Read-Only Memory (ROM), Flash memory (e.g., a Secure Digital (SD) memory card, a mini-SD memory card, and/or a micro-SD memory card), magnetic memory, optical memory, Universal Serial Bus (USB) memory devices, hard disk memory, external memory, and other types of computer-readable storage media. In implementations, the sample detector 202 and/or memory module 256 may include removable Integrated Circuit Card (ICC) memory, such as memory provided by a Subscriber Identity Module (SIM) card, a Universal Subscriber Identity Module (USIM) card, a Universal Integrated Circuit Card (UICC), and so on.

In implementations, a variety of analytical devices can make use of the structures, techniques, approaches, and so on described herein. Thus, although IMS systems 200 are described herein, a variety of analytical instruments may make use of the described techniques, approaches, structures, and so on. These devices may be configured with limited functionality (e.g., thin devices) or with robust functionality (e.g., thick devices). Thus, a device's functionality may relate to the device's software or hardware resources, e.g., processing power, memory (e.g., data storage capability), analytical ability, and so on.

Although the subject matter has been described in language specific to structural features and/or methodological acts, it is to be understood that the subject matter defined in the appended claims is not necessarily limited to the specific features or acts described. Although various configurations are discussed the apparatus, systems, subsystems, components and so forth can be constructed in a variety of ways without departing from this disclosure. Rather, the specific features and acts are disclosed as example forms of implementing the claims.

What is claimed is:

1. A sample detector, comprising:
a housing defining a sample inlet configured to receive a fluid;
a seal member disposed proximate to the sample inlet and at least partially defining an inlet path in fluid communication with the sample inlet defined by the housing;
a seat member configured to seat with respect to the seal member and obstruct the inlet path;
an actuation member configured to move the seat member between at least a first position in seated engagement with the seal member and a second position out of seated engagement with the seal member; and
a biasing member disposed proximate to the sample inlet for biasing the seat member into seated engagement with the seal member in the first position.

2. The sample detector as recited in claim 1, wherein the seal member comprises at least one of a gasket, a washer, or an O-ring seal.

3. The sample detector as recited in claim 1 or 2, wherein the biasing member comprises at least one of a magnet or a spring for biasing the seat member.

4. The sample detector as recited in any preceding claim, wherein the biasing member at least partially defines the inlet path in fluid communication with the sample inlet defined by the housing.

5. The sample detector as recited in any preceding claim, further comprising a second biasing member disposed apart from the sample inlet for biasing the seat member into the second position out of seated engagement with the seal member.

6. The sample detector as recited in any preceding claim, further comprising a keeper coupled with the seat member and configured to allow the seat member to move between the first position and the second position.

7. The sample detector as recited in claim 6, wherein the keeper is defined by the housing.

8. The sample detector of any preceding claim in which the sample inlet comprises a pinhole sample inlet.

9. A method, comprising:
receiving a fluid at a sample inlet of a sample detector;
moving a seat member from a first position out of seated engagement with a seal member to a second position in seated engagement with the seal member, the seal member disposed proximate to the sample inlet and at least partially defining an inlet path in fluid communication with the sample inlet;
biasing the seat member into seated engagement with the seal member in the second position; and
obstructing the inlet path when the seat member is seated with respect to the seal member.

10. The method as recited in claim 9, further comprising:
receiving a fluid at a second sample inlet of the sample detector;
moving a second seat member from a third position out of seated engagement with a second seal member to a fourth position in seated engagement with the second seal member, the second seal member disposed proximate to the second sample inlet and at least partially defining a second inlet path in fluid communication with the second sample inlet;
biasing the second seat member into seated engagement with the second seal member in the fourth position; and
obstructing the second inlet path when the second seat member is seated with respect to the second seal member.

11. The method as recited in claim 10, wherein the first seat member and the second seat member are moved using an actuation member common to both the first seat member and the second seat member.

12. The method as recited in claim 9, 10 or 11, wherein the seal member comprises at least one of a gasket, a washer, or an O-ring seal.

13. The method as recited in any of claims 9 to 12, wherein biasing the seat member into seated engagement with the seal member in the first position comprises biasing the seat member into seated engagement with the seal member in the first position via at least one of a magnet or a spring.

14. The method as recited in any of claims 9 to 13, further comprising biasing the seat member out of seated engagement with the seal member in the first position out of seated engagement with the seal member.

15. The method of any of claims 9 to 14 in which the sample inlet comprises a pinhole sample inlet.

16. The method of any of claims 10 to 15 in which the second sample inlet comprises a pinhole sample inlet.

17. An inlet closure assembly, comprising:
a seal member disposed in a housing defining an inlet configured to receive a fluid, the seal member at least partially defining an inlet path in fluid communication with the inlet defined by the housing;
a seat member configured to seat with respect to the seal member and obstruct the inlet path;
an actuation member configured to move the seat member between at least a first position in seated engagement with the seal member and a second position out of seated engagement with the seal member; and
a biasing member for biasing the seat member into seated engagement with the seal member in the first position.

18. The inlet closure assembly as recited in claim 17, wherein the seal member comprises at least one of a gasket, a washer, or an O-ring seal.

19. The inlet closure assembly as recited in claim 17 or 18, wherein the biasing member comprises at least one of a magnet or a spring for biasing the seat member.

20. The inlet closure assembly as recited in claim 17, 18 or 19, wherein the biasing member at least partially defines the inlet path in fluid communication with the inlet defined by the housing.

21. The inlet closure assembly as recited in any of claims 17 to 20, further comprising a second biasing member disposed apart from the inlet for biasing the seat member into the second position out of seated engagement with the seal member.

22. The inlet closure assembly as recited in any of claims 17 to 21, further comprising a keeper coupled with the seat member and configured to allow the seat member to move between the first position and the second position.

23. The inlet closure assembly as recited in claim 22, wherein the keeper is defined by the housing.
